(19) United States
(12) Patent Application Publication
(10) Pub. No.: US 2025/0208879 A1
(43) Pub. Date: Jun. 26, 2025

(54) TECHNIQUES FOR STALLED ROUTING ASSOCIATED WITH NUMBER-THEORETIC- TRANSFORM AND INVERSE-NUMBER-THEORETIC-TRANSFORM COMPUTATIONS

(71) Applicant: Intel Corporation, Santa Clara, CA (US)

(72) Inventors: Raghavan KUMAR, Hillsboro, OR (US); Minxuan ZHOU, San Diego, CA (US); Christopher B. WILKERSON, Vancouver, WA (US); Sanu K. MATHEW, Portland, OR (US); Anupam GOLDER, Hillsboro, OR (US)

(21) Appl. No.: 18/394,984

(22) Filed: Dec. 22, 2023

(51) Int. Cl. G06F 9/38; G06F 15/80; H04L 9/00

(52) U.S. Cl. CPC G06F 9/3887; G06F 15/8023; H04L 9/008

(57) ABSTRACT

Examples include techniques for contention-free routing for number-theoretic-transform (NTT) or inverse-NTT (iNTT) computations routed through a parallel processing device. Examples include a tile array that includes a plurality of tiles arranged in a 2-dimensional mesh interconnect-based architecture. Each tile includes a plurality of compute elements configured to execute NTT or iNTT computations associated with a fully homomorphic encryption workload. Contention-free routing to include use of selective stalls and destination ports indicated in routing tables maintained at tiles of the tile array can facilitate NTT/iNTT computation throughput through the parallel processing device.

### STATEMENT REGARDING FEDERALLY SPONSORED RESEARCH

This invention was made with Government support under contract number HR0011-21-3-0003 awarded by the Department of Defense. The Government has certain rights in this invention.

### TECHNICAL FIELD

Examples described herein are generally related to techniques associated with number-theoretic transform (NTT) and inverse-NTT (iNTT) computations routed through a parallel processing device for accelerating fully homomorphic encryption (FHE) workloads.

### BACKGROUND

Number-theoretic-transforms (NTT) and inverse-NTT (INTT) can be important operations for accelerating fully homomorphic encryption (FHE) workloads. NTT/iNTT computations/operations can be used to reduce runtime complexity of polynomial multiplications associated with FHE workloads from O(n²) to O(n log n), where n is the degree of the underlying polynomials. NTT and iNTT operations can be mapped for execution by computational elements included in a parallel processing device. The parallel processing device could be referred to as a type of accelerator device to accelerate execution of FHE workloads.

### BRIEF DESCRIPTION OF THE DRAWINGS

FIG. 1 illustrates an example system.

FIG. 2 illustrates an example connection scheme.

FIG. 3 illustrates an example NTT routing schedule.

FIG. 4 illustrates an example tile sub-system.

FIG. 5 illustrates an example tile.

FIG. 6 illustrates an example routing table entry format and an example direction encoding.

FIG. 7 illustrates a first example router sub-system for a tile.

FIG. 8 illustrates a second example router sub-system for a tile.

FIG. 9 illustrates example top channel stalled paths.

FIG. 10 illustrates example bottom channel stalled paths.

FIG. 11 illustrates an example logic flow.

FIG. 12 illustrates an example computing system.

FIG. 13 illustrates a block diagram of an example processor and/or System on a Chip (SoC) that may have one or more cores and an integrated memory controller.

### DETAILED DESCRIPTION

In some examples, NTT and iNTT operations can be mapped for execution by computational elements included in a parallel processing device. The parallel processing device may include reconfigurable compute elements such reconfigurable butterfly circuits. These reconfigurable butterfly circuits can be arranged in separate groups organized in a plurality of tiles. These butterfly circuits can perform single instruction, multiple data (SIMD) add, multiply, multiply-and-accumulate, subtraction, etc. Unlike other SIMD operations, NTT operations also require shuffling of polynomial coefficients after computation on groups of butterfly circuits included in a respective tile. For example, for large polynomial ring sizes, this involves a significant amount of data movement between tiles. For example, a parallel processing device can include around 8,192 configurable butterfly circuits organized across 64 tiles. This equates to 128 butterfly circuits per tile and if each butterfly circuit has a 64 bit output, around 8,192 bits or 1 kilobyte (KB) of data can be moved across or between a pair of tiles. So for a 64 tile array, the resulting data movement would be about 64 KB. Moving this relatively large amount of data across all tiles of the parallel processing device needs a routing fabric to facilitate efficient data movement to achieve high throughput for NTT or iNTT operations. Efficient data movement can improve an overall performance of FHE workloads executed by the parallel processing device or accelerator implementing NTT/iNTT operations.

A first solution for data movement across tiles of a parallel processing device that includes processing elements such as butterfly circuits can involve use of dedicated point-to-point connections between tiles. For example, a dedicated point-to-point interconnect that involves Manhattan routing paths between tiles for a 64-tile array with 8,192 butterfly circuits organized in an 8×8 grid would need links capable of moving 1 KB of data between tiles, as mentioned above for NTT or iNTT operations. These 1 KB wide point-to-point connections move data from a source tile to a destination tile in the 64 tile array. This type of dedicated point-to-point connection scheme for NTT or iNTT operations can require a significant amount of routing channels and resources to ensure contention free routing for data movement between a source tile and a destination tile. Silicon area during a physical design flow could grow as much as 2-3 times to accommodate this type of dedicated point-to-point connection scheme to implement NTT/iNTT operations/computations.

A second solution that attempts to mitigate silicon area growth for tile to tile data movement is to serialize or break up data movement via point-to-point connections into small chunks. The smaller chunks can reduce the width of data paths but a penalty will occur as NTT/iNTT operations/computations throughput will be reduced. Reduced throughput for NTT/iNTT operations/computations reduces overall performance for execution of FHE workloads.

A third solution that is described in greater detail below, involves use of a scalable and reconfigurable parallel processing device that has compute elements arranged to execute NTT and iNTT operations/computations and can be configured to route data in packets between tiles based on programmable contention-free routing schedules for NTT/iNTT operations/computations that can be initiated at a beginning of an FHE workload execution. The programmable contention-free routing schedules cause generation or creation of routing tables for use to route data between tiles arranged in a 2-dimensional (2D) mesh array. This third solution can be implemented such that all compute elements of a tile inject NTT/iNTT computation outputs simultaneously into an interconnect fabric of the 2D mesh array. The simultaneous output can result in a significant amount of congestion in the interconnect fabric and this congestion can limit overall NTT/iNTT computation throughput.

The third solution addresses problems mentioned above for the first two solutions in a manner that can boost throughput compared to serialized point-to-point connections and enables a user to program contention-free routing schedules that can provide latency versus throughput trade-off options to minimize silicon area growth. However, as mentioned above, simultaneous outputs can result in congestion of an interconnect fabric. As presented in this disclosure, examples are described that includes a tile router architecture to stall routing of computation results for at least some paths through a 2D mesh array to minimize or reduce interconnect fabric congestion and improve overall NTT/iNTT computation throughput.

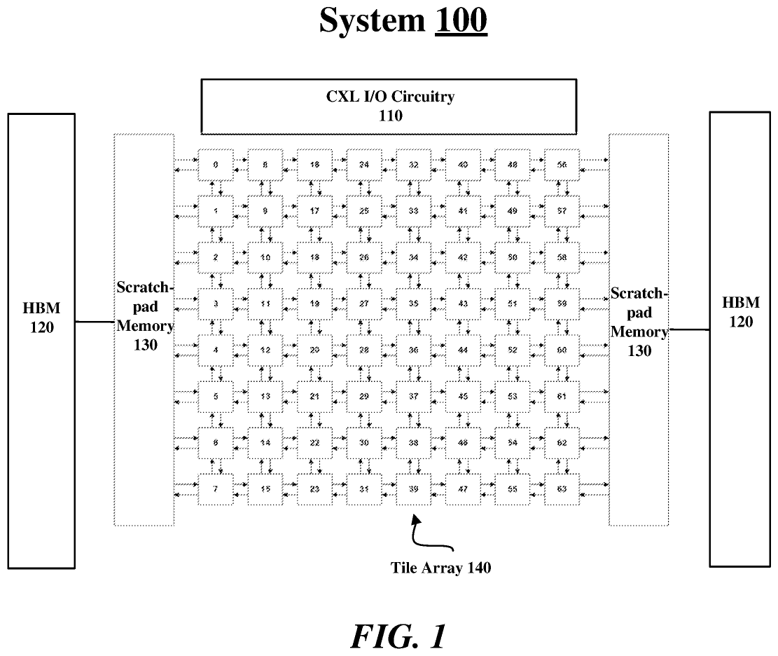

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratchpad memory 130 or tile array 140.

In some examples, system 100 can be configured as a parallel processing device or accelerator to perform NTT/iNTT operations/computations for accelerating FHE workloads. For these examples, CXL I/O circuitry 110 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of tile array 140. For example, data (e.g., ciphertext or processed ciphertext) may be received to or pulled from HBM 120 and CXL I/O circuitry 110 can facilitate the data movement into or out of HBM 120 as part of execution of accelerated FHE workloads. Also, scratchpad memory 130 can be a type of memory (e.g., register files) that can be proportionately allocated to tiles included in tile array 140 to facilitate execution of the accelerated FHE workloads and to perform NTT/iNTT operations.

In some examples, as described in more detail below, tile array 140 can be arranged in an 8×8 tile configuration as shown in FIG. 1 that includes tiles 0 to 63. For these examples, each tile can include, but is not limited to, 128 compute elements (not shown in FIG. 1). Also, as described in more detail later, the 128 compute elements can be 128 separately reconfigurable butterfly circuits, which are configured to compute output terms associated with polynomial coefficients for NTT/iNTT operations/computations. As shown in FIG. 1, tiles 0 to 63 can be interconnected via point-to-point connections via a 2D mesh interconnect-based architecture. The 2D mesh enables communications between adjacent tiles using single-hop links. Tiles included in tile array 140 can be augmented with router circuitry that can route data received via inputs or sent via outputs across all 4 directions.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data or provide executed results are contemplated.

Examples are not limited to HBM such as HBM 120 for receiving data to be processed or to store information associated with instructions to execute an FHE workload or execution results of the FHE workload. Other types of volatile memory or non-volatile memory are contemplated for use in system 100. Other type of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). An SoC is a term often used to describe a device or system having a compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (e.g., butterfly circuits) and associated circuitry (e.g., I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

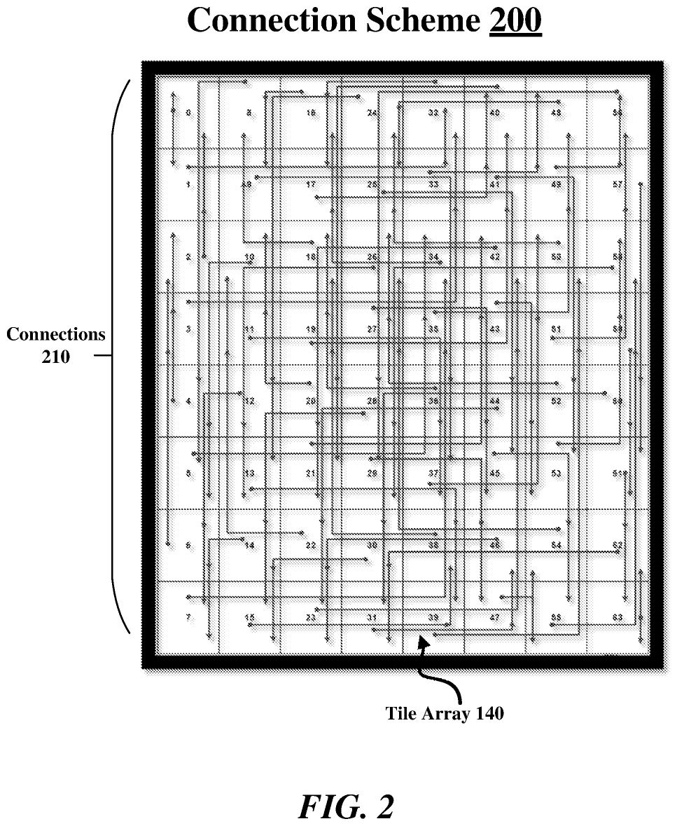

FIG. 2 illustrates an example connection scheme 200. According to some examples, connection scheme 200 shows how an 8×8 grid of tiles 0-63 of tile array 140 can be interconnected via connections 210 to perform an NTT operation on polynomials with 16,384 coefficients. For these examples, each tile can include 128 compute elements or butterfly circuits. Each point-to-point link included in connections 210 between tiles can be configured to carry 64 bits output from each of 128 butterfly circuits included in a single tile. So, each point-to-point link included in connections 210 can be configured to carry around 8,192 bits or 1 KB of data (e.g., in a packet form).

Connection scheme 200 is an example of how paths can be routed between tiles to implement an NTT operation using a Manhattan source-destination routing scheme. For implementing an iNTT operation, paths between tiles included in tile array 140 will have source and destination tile ordering reversed. In other words, the direction of the arrows shown in FIG. 2 are reversed. For example, for implementing an NTT operation, data from a source tile of 1 is routed to a destination tile of 32 through tiles 9, 17, 25 and 33. For implementing an iNTT operation, tile 32 is the source and tile 1 is the destination and the routing of data is through 33, 25, 17 and 9 to reach destination tile 1.

According to some examples, a scalable and reconfigurable method to implement connections between tiles executing NTT or iNTT operations/computations associated with an FHE workload can occur over a 2D mesh interconnect such as shown in FIG. 1 for system 100. The scalable and reconfigurable method can enable a contention-free routing by construction. As described in more detail below, tiles 0-63 of tile array 140 can each include router circuitry that is arranged to possible stall incoming packets and then direct incoming packets to appropriate output or destination ports using metadata included in entries of routing tables. As data routing paths for NTT/iNTT operations/computations are known or predetermined, a user can program contention-free routing schedules (with or without stalls) and program metadata to entries of routing tables at a beginning of an FHE workload. Butterfly circuitry included in each tile of tile array 140 can be arranged to execute in a SIMD nature for the FHE workload. The SIMD nature for the FHE workload enables a reuse of router circuitry between NTT and iNTT operations/computations by replicating only the routing table, while sharing decoder circuitry.

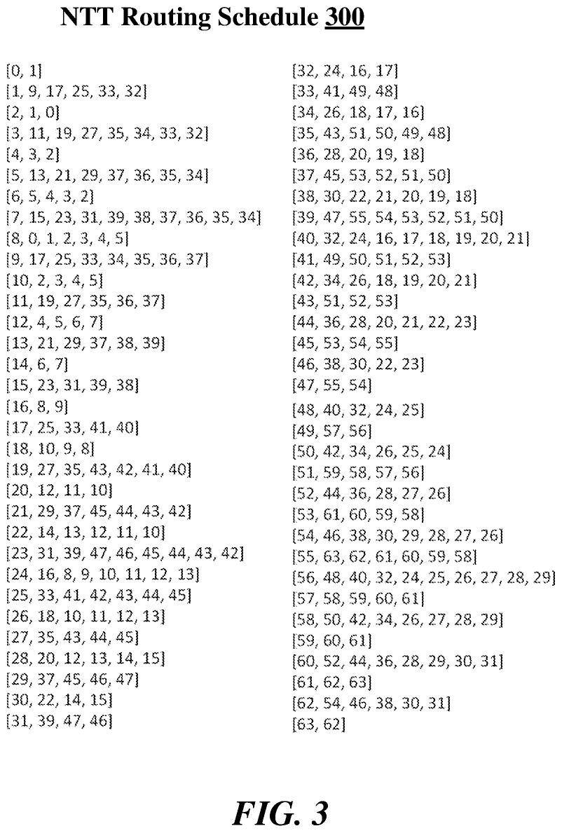

FIG. 3 illustrates an example NTT routing schedule 300. As mentioned previously, data movement for NTT and iNTT operations/computations can be achieved over a 2D mesh interconnect-based architecture as shown in FIG. 1 using a Manhattan source-destination routing scheme as shown in FIG. 2. NTT routing schedule 300 can be encoded into routing tables that provide contention-free routing paths for router circuitry to use for routing packets through a tile array. Contention can be defined as a scenario, where two incoming packets received at router circuitry at a tile have a same output port for routing. Routing paths encoded in routing tables based on NTT routing schedule 300 can be constructed such that they are contention-free by construction. Contention-free routes for all 64 tiles included in tile array 140 are shown in FIG. 3 for a 16K polynomial ring size example NTT operations/computations.

As can be seen in FIG. 3 for NTT routing schedule 300, route or path lengths between source and destination tiles range anywhere between 1 hop and 9 hops. Butterfly units included in each tile can inject output packets into the interconnect fabric of the 2D mesh array simultaneously, and the outputs can reach their destination tiles at different clock cycles, with a worst-case arrival time of 9 clock cycles. Different hop lengths between source and destination tiles can provide an opportunity for shorter hop length packets to be injected into the interconnect fabric of the 2D mesh array later than longer hop length packets, while still maintaining the worst-case latency of 9 clock cycle. In other words, selective stalling of injection of packets into an interconnect fabric of the 2D mesh array for shorter hop length packets can help to minimize or reduce overall congestion in the interconnect fabric of the 2D mesh array at a given point in time. A reduction in overall congestion can improve overall throughput for NTT operations/computations. As described in more detail below, router circuitry at each tile can be configured to selectively stall packets based on programmable routing table entries to minimize or reduce overall congestion in the interconnect fabric of the 2D mesh array.

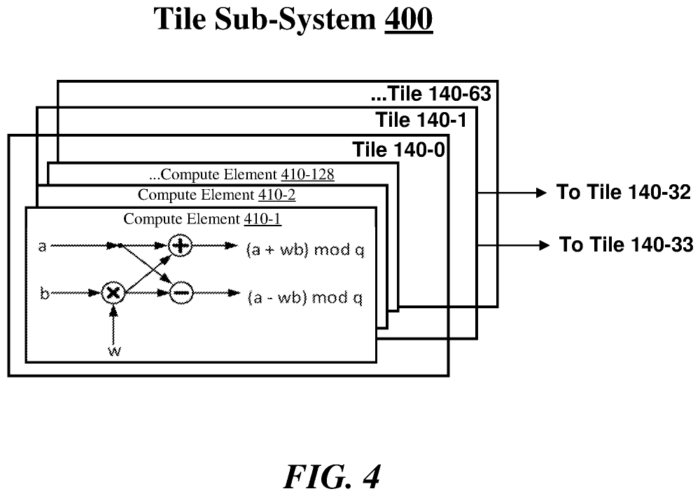

FIG. 4 illustrates an example tile sub-system 400. According to some examples, as shown in FIG. 4, tile sub-system 400 includes tiles 140-0 to 140-63 of tile array 140. Also, compute elements 410-1 to 410-128 illustrate the 128 compute elements included in tile 140-0. For these examples, compute elements 410-1 to 410-128 can include decimation-in-time (DIT) butterfly circuits that includes a modular multiplier coupled to an adder and subtractor. Although not shown in FIG. 4, other types of butterfly circuits such as decimation-in-frequency (DIF) butterfly circuits are contemplated, so examples are not limited to DIT butterfly circuits. NTT operations/computations for FHE workloads can be performed by the 128 compute elements configured as butterfly circuits and included in each tile of tile array 140. The NTT operations can include each butterfly circuit computing output terms a+b+w, a−b*w, where a and b are polynomial coefficients, while w is a twiddle factor, which depends on an underlying modulus term.

Unlike add, subtraction and multiplication operations, NTT operations/computations also involve a fixed permutation of butterfly circuit outputs, where a permutation pattern depends on the degree of an underlying polynomial. Connection scheme 200 shown in FIG. 2 depicts a permutation network for a 16K polynomial ring size mapped to tile array 140 in an 8×8 grid. According to some examples, the two outputs lanes or channels (e.g., top and bottom channels) from butterfly circuits included in the 128 compute elements of a tile are sent to two destination tiles, where each destination tile is to receive one of the output lanes or channels. For example, as shown in FIG. 4, output channels from tile 140-1 are sent to tiles 140-32 and 140-33.

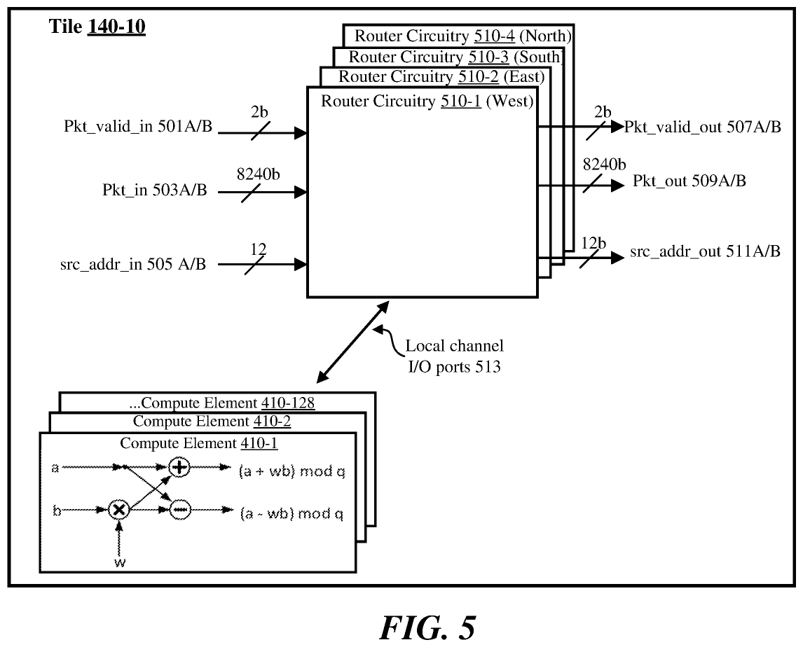

FIG. 5 illustrates an example tile 140-10 from tile array 140. In some examples, as shown in FIG. 5, tile 140-10 includes router circuitry 510-1 to 510-4. For these examples, router circuitry 510 is replicated 4 times to service up to 4 directions (west, east, south, north) simultaneously/concurrently and to also service routing of data to local compute elements 410-1 to 410-128 if data is destined for tile 140-10. Example routing activities that occur within/by components of router circuitry 510 are described in more detail below.

According to some examples, in order to accommodate two output lanes or channels from compute elements 410-1 to 410-128, router circuitry 510 can implement two identical routing channels A (top) and B (bottom). Routing channels A/B are not shown in FIG. 5 but are implied via Pkt_valid_in 501A/B, Pkt_in 503A/B, src-addr_in 505A/B, Pkt_valid-out 507A/B, Pkt_out 509A/B and src_addr_out 511A/B signals. For example, Pkt_valid_in 501A/B signal is shown in FIG. 5 as including a 2 bit signal-1 bit for the A channel and 1 bit for the B channel. Similarly, the number of bits shown for the other signals are equally split between the A and B channels.

In some examples, Pkt_valid_in 501A/B signals can carry 2 bits of data to indicate a valid packet has been sent to tile 140-10, Pkt_in 503A/B signals can carry 8240 bits of data included in packets to be processed by compute elements 410, src_addr_in 505A/B signals can carry 12 bits of data to indicate a source address for data included in packet to be processed for an NTT/iNTT operation/computation. Also, Pkt_valid_out 507A/B signals can carry 2 bits of data to indicate that tile 140-10 is sending a valid packet to a next tile, Pkt_out 509A/B signals can carry 8240 bits of data included in packets to be sent to a destination tile, and src_addr_out 511A/B signals can carry 12 bits to indicate the source address for the data included in a packet to be processed for the NTT/iNTT operation/computation. Examples are not limited to the bits shown in FIG. 5 for A/B signals that are based on a 16K polynomial mapped to tile array 140. The size of the polynomial ring mapped to a tile array will increase or decrease bits carried by at least Pkt_in 503A/B, src_addr_in 505A/B, Pkt_out 509A/B, or src_addr_out 511A/B signals to implement NTT/iNTT operations.

Although only tile 140-10 is shown in FIG. 5, all tiles included in tile array 140 can have the same replicated router circuitry.

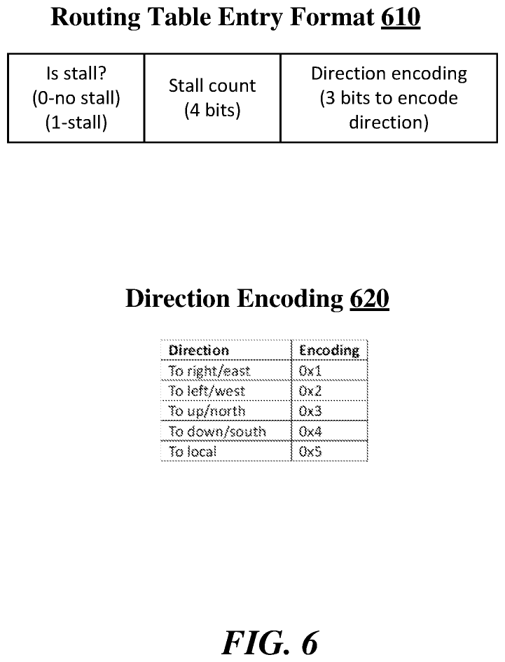

FIG. 6 illustrates an example routing table entry format 610 and example direction encoding 620. In some examples, routing table entry format 610 can be arranged to program routing table entries maintained at router circuitry of tile (e.g., router circuitry 510). For these examples, programmable routing table metadata can be loaded to entries assigned to source addresses in routing tables maintained at the router circuitry. Routing table entry format 610, as shown in FIG. 6, includes a 1-bit stall indicator, a 4-bit stall count value and a 3-bit direction encoding.

According to some examples, as shown in FIG. 6, direction encoding 620 provides example encodings to indicate which output or destination port to use as a routing path to send in-transit or locally generated packets in 4 possible directions (0×1-0×4), as well as a local delivery (0×5) if the current tile is the destination for a received packet. In an example of an 8×8 tile array, a routing table can have 64 source address entries. Metadata for entries assigned to respective source addresses can contain 3-bit values for direction encoding that encode the 4 possible directions, as well as a local delivery as shown in direction encoding 620. The 3-bit direction encoding value can be based on a contention-free route through the 8×8 tile array from the source tile to a destination tile for an NTT/iNTT operation/computation.

In some examples, a source address of a received packet (e.g., received via src_add_in 505), can be used in a look-up table operation to fetch routing table metadata for a routing table entry assigned to that source address from a routing table, the routing table entry in example routing table entry format 610. For these examples, when the stall bit is set to ‘0’, butterfly circuit outputs of a tile or the in-transit packet can be sent to an output or destination port of router circuitry as indicated in the 3-bit direction encoding value. When the stall bit is set to ‘1’, butterfly circuit outputs of the tile or the in-transit packet can be stalled or held back from being sent to an output port of the router circuitry. As described in more detail below, router circuitry can include stall registers to temporarily capture the butterfly circuitry outputs or the in-transit packet, and decrement a counter that can be initialized with the state set to the 4-bit stall count value. As the counter reaches the value of ‘0’, the stalled butterfly circuitry outputs or in-transit packet can then be sent to an appropriate output or destination port of the router circuitry based on the 3-bit direction encoding value.

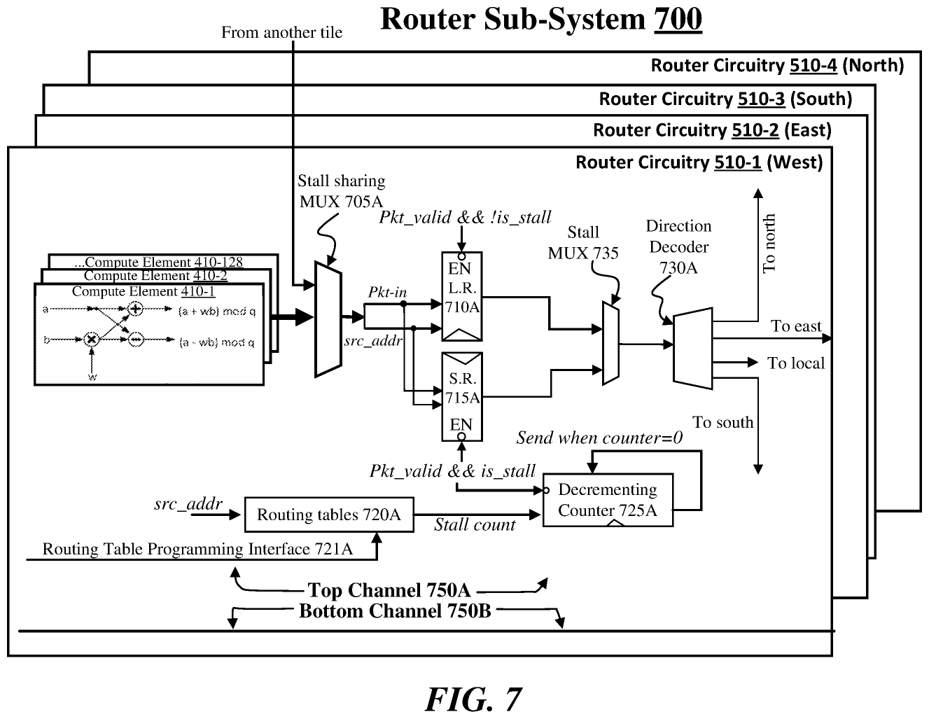

FIG. 7 illustrates an example router sub-system 700. In some examples, router sub-system 700 shows components of router circuitry 510-1 (e.g., router circuitry 510-1 for tile 140-10) For these examples, as shown in FIG. 7 a top channel 750A of router circuitry 510-1 includes a stall sharing multiplexer (MUX), a link register (L.R.) 710A, a stall register (S.R.) 710A, a routing table programming interface 721A, routing tables 720A, a decrementing counter 725, a direction decoder 730A and a stall MUX 735. Routing tables 720A can include an NTT and iNTT routing tables that are based on contention-free routes through tile array 140 for NTT/iNTT operations/computations. Routing tables 720A can be reconfigured to include source address assigned routing table entries having metadata as mentioned above for routing table entry format 610 for router circuitry 510-1 via routing table programming interface 721A. In some examples, programmable registers or allocated memory of a tile can be used to maintain routing tables 720A and these programmable registers or allocated memory can be programmed/accessed via routing table programming interface 721A to configure or reconfigure routing tables 720A (e.g., at initiation of an FHE workload).

Although not shown in FIG. 7 bottom channel 750B includes duplicated components of a stall sharing MUX 705B, an L.R. 710B, an S.R. 715B, a routing table programming interface 721B, routing tables 720B, a decrementing counter 725A, a direction decoder 730B, and a stall MUX 735. According to some examples, identical components included in top channel 750A and bottom channel 750B can be designed to accommodate two output lanes or channels for data generated by compute elements 410-1 to 410-128 included in a tile or for in-transit packets that include data generated by compute elements at other tiles.

As mentioned above and shown in both FIGS. 5 and 7, router circuitry 510-1 is replicated in router circuitry 510-2, 510-3 and 510-4 to service up to 4 directions simultaneously. In some examples, an incoming packet (e.g., received via Pkt_in 503A) associated with a corresponding valid signal (e.g., received via Pkt_valid_in 501A) and a source address of the packet (e.g., indicated in src_addr_in 505A). For these examples, the source address of the packet can be used in a look-up table operation to fetch a routing table entry of a routing table included in routing tables 720A, the routing table entry assigned to or corresponding to the source address. The routing table entry to have the metadata as mentioned above for routing table entry format 610 that can include a 1-bit stall value, a 3-bit stall count value and a 3-bit direction encoding value.

According to some examples, if the 1-bit stall value in routing table entry metadata is set to ‘0’, depending on whether the source address is from compute elements 410-1 to 410-128 or from another tile, the packet is routed through stall sharing MUX 705A to L.R. 710A. For these examples, stall MUX 735 enables the packet to be routed by direction decoder 730A to a destination port based on the 3-bit direction encoding value (e.g., according to example direction encoding 620).

According to some examples, if the 1-bit stall value in routing table entry metadata is set to ‘1’, depending on whether the source address is from compute elements 410-1 to 410-128 or from another tile, the packet is routed through stall sharing MUX 705A to S.R. 715A. For these examples, the 4-bit stall count value in the routing table entry metadata is used to initialize a stall count for decrementing counter 725A. For example, if the 4-bit stall count value was set to a value of ‘4’, decrementing counter 725A is initialized to a count of 4 that is decremented (e.g., at a unit of time approximately equal to a clock cycle) down to a count of 0. When reaching a count of 0, the packet is to be sent through stall MUX 735 and the packet can be routed by direction decoder 730 to a destination port based on the 3-bit direction encoding value included in the routing table entry metadata.

In some examples, stall sharing MUX 705A can be configured according to a routing schedule that can allow L.R. 710A or S.R. 715A to be used for packets for one of packets output from compute elements 410-1 to 410-128 and packets received from other tiles. For example, the routing schedule may cause packets output from compute elements 410-1 to 410-128 to be routed through L.R. 710A first (if no stall) or through S.R. 715A first (if stalled).

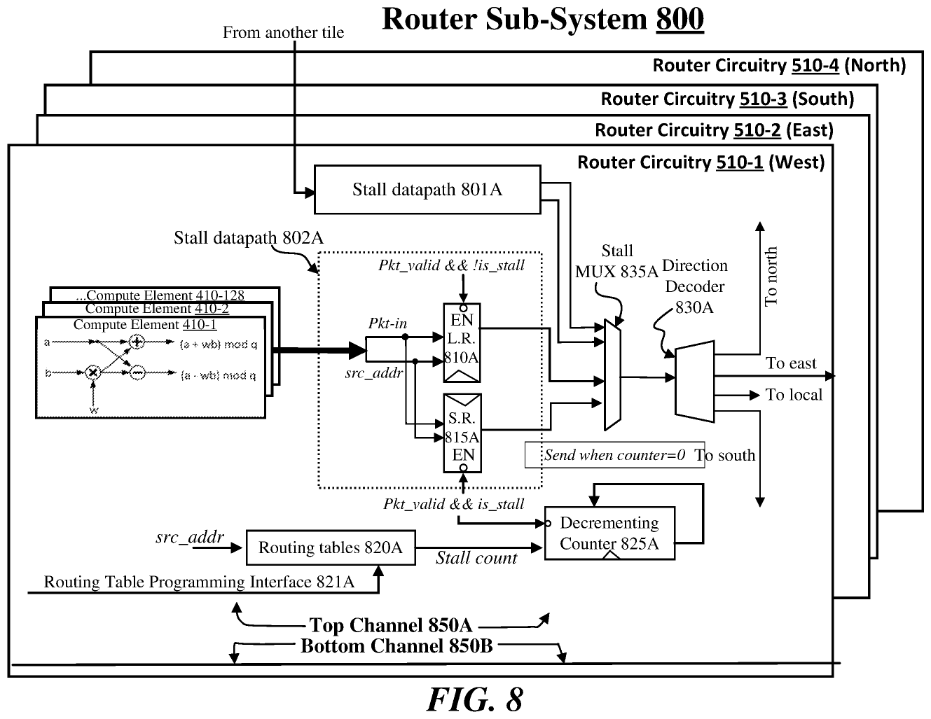

FIG. 8 illustrates an example router sub-system 800. In some examples, router sub-system 800 has similar components to router sub-system 700 with the exception of separate stall datapaths. For these examples, as shown in FIG. 8, a stall datapath 801A can be configured to route and/or stall packets received from another tile and a stall datapath 802A can be configured to route and/or stall packets output from compute elements 410-1 to 410-128. Although not shown in FIG. 8, stall datapath 801A can also include a similar set of link registers and stall registers as shown for stall datapath 801A. The separate stall datapaths can enable a more relaxed routing schedule constraint as two packets having different source addresses can be stalled concurrently. Stall MUX 835A can be configured to enable direction decoder 830A to route packets from stall datapaths 801A or 802A according to the more relaxed routing schedule constraint.

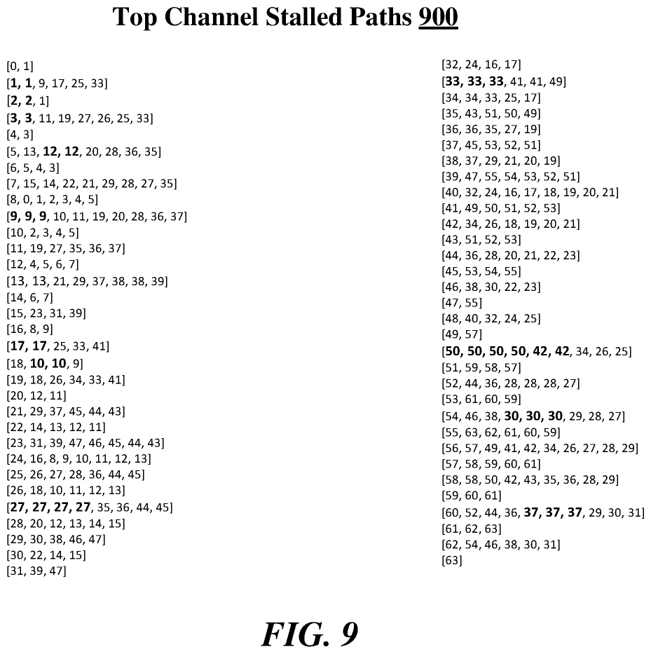

FIG. 9 illustrates example top channel stalled paths 900. According to some examples, top channel stalled paths 900 show example stalls for both compute element/butterfly packet outputs and in-transit packets for paths through an 8×8 tile array. For these examples, the stalled paths illustrate how stalls can be inserted in contention-free paths through an 8×8 array tiles such as shown in FIG. 2 for tile array 140 and based on NTT routing schedule 300 shown in FIG. 3. The bold, repeated numbers indicate stalls in a given path.

In some examples, bold, repeated numbers at a beginning of a path indicates the outputs of compute elements at that tile are stalled for at least one unit of time (e.g., a clock cycle). For example, bold, repeated numbers at tiles 1, 2, 3, 17, 27, 33 and 50 can have their respective compute element outputs stalled from being routed through a destination port between 1 clock cycle to 3 clock cycles. Routing tables maintained at routing circuitry of these tiles, similar to what was mentioned above for routing sub-systems 700 or 800, can have routing table entry metadata to indicate these stalls before sending the outputs of compute elements to a destination output port.

According to some examples, bold, repeated numbers not at a beginning of a path indicate that in-transit packets, received from other tiles are to be stalled. For example, bold, repeated numbers for a path originating from or having a source address for tile 5 can indicate that packets from tile 5, when received at tile 12, are to be stalled for one unit of time before being routed to tile 20. Similarly, bold, repeated numbers for a path originating from or having a source address for tile 60 can indicate that packets from tile 60, when received at tile 37, are to be stalled for 2 units of time before being routed to tile 29.

A path for tile 63 is not included in top channel stalled paths 900 because the interconnect between tiles 63 and 62 in this path is only used at a bottom channel of router circuitry maintained at tile 63, while the top channel delivers the packet from tile 63 to itself (e.g., local destination port). The paths shown in FIG. 9 for top channel stalled paths 900 can represent one of multiple options for contention-free paths with selective stalls for compute element or in-transit packets through tile array 140 for a top channel. These multiple options for contention-free paths with selective stalls can be used to program top channel routing tables maintained at tile router circuitry to reduce overall congestion in the interconnect fabric that interconnects tiles 0-63 and to improve throughput of NTT/iNTT computations/operations through tile array 140.

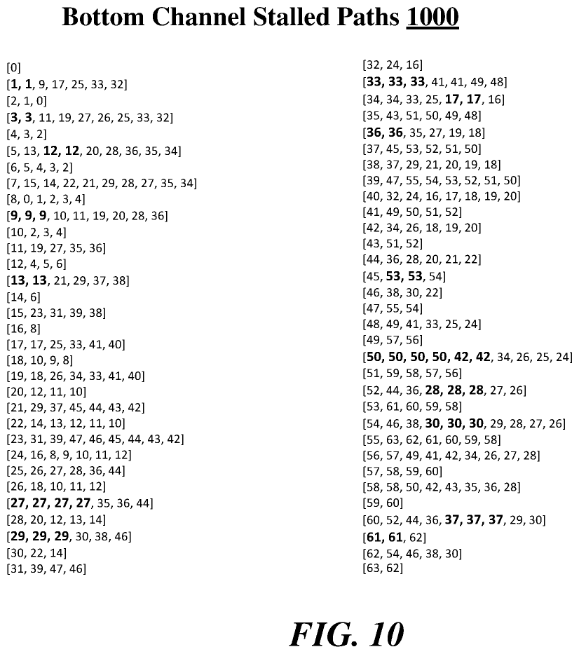

FIG. 10 illustrates example bottom channel stalled paths 1000. According to some examples, bottom channel stalled paths 900 show example stalls for both compute element/butterfly packet outputs and in-transit packets for paths through an 8×8 tile array. For these examples, the stalled paths illustrate how stalls can be inserted in contention-free paths through an 8×8 array tiles such as shown in FIG. 2 for tile array 140 and based on NTT routing schedule 300 shown in FIG. 3. The stalls shown in FIG. 10 are similar for several paths of tiles in tile array 140 as the stalls shown for top channel stalled paths 900 in FIG. 10, but there are several paths that include stalls for bottom channel stalled paths 1000 that do not include stalls in top channel stalled paths 900 and vice versa. The difference is due to a routing scheme that attempts to avoid congestion in an interconnect fabric that interconnects tiles 0-63 that can each simultaneously output packets via top and bottom channels into the interconnect fabric.

A path for tile 0 is not included in bottom channel stalled paths 1000 because the interconnect between tiles 0 and 1 in this path is only used at a top channel of router circuitry maintained at tile 0, while the bottom channel delivers the packet from tile 0 to itself (e.g., local destination port). The paths shown in FIG. 10 for bottom channel stalled paths 1000 can represent one of multiple options for contention-free paths with selective stalls for compute element or in-transit packets through tile array 140 for a bottom channel. These multiple options for contention-free paths with selective stalls can be used to program bottom channel routing tables maintained at tile router circuitry to reduce overall congestion in the interconnect fabric that interconnects tiles 0-63 and to improve throughput of NTT/iNTT computations/operations through tile array 140.

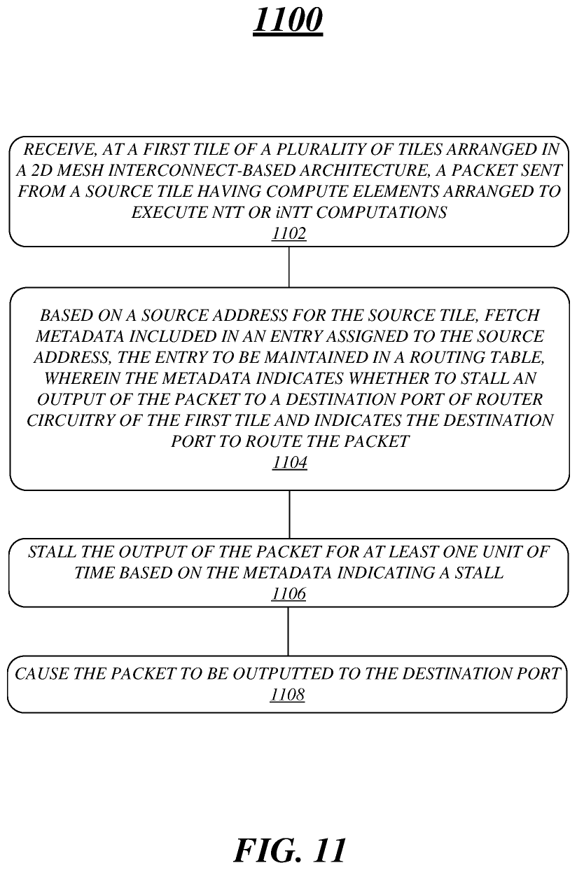

FIG. 11 illustrates an example logic flow 1100. Logic flow 1100 is representative of the operations implemented by logic and/or features of a router circuitry resident on or closely coupled with a tile. For example, logic and/or features of router circuitry 510-1, 510-2, 510-3 or 510-4 as shown in FIGS. 5 and 7 and described above for router sub-systems 700 or 800 as shown in FIGS. 7-8. The router circuitry can be configured to implement a packet output stall scheme such as described above for router sub-systems 700 or 800 using top or bottom channel stalled paths 900 or 1000, shown in FIGS. 9-10. The packet output stall scheme can be implemented to program routing tables with metadata to include in routing table entries assigned to source addresses of tiles, the programmed routing tables maintained and/or used by the router circuitry. Top and bottom channel router circuitry can be included in a tile such as tile 140-10 of tile array 140 that includes a plurality of compute elements such as compute elements 410-1 to 410-128 as shown in FIGS. 4 and 5.

In some examples, as shown in FIG. 11, logic flow 1100 at block 1102 can receive, at a first tile of a plurality of tiles arranged in a 2-D mesh interconnect-based architecture, a packet sent from a source tile having compute elements arranged to execute NTT or iNTT computations. For example, route circuitry 510-1 of tile 140-10 receives a packet sent from a source tile included in tile array 140 in association with NTT computations, the packet received via an Pkt_in 503A signal of top channel 750A.

According to some examples, logic flow 1100 at block 1104 can based an assigned source address for the source tile, fetch metadata included in an entry assigned to the source address, the entry to be maintained in a routing table, wherein the metadata indicates whether to stall an output of the packet to a destination port of the router circuitry and indicates the destination port to route the packet. For example, router circuitry 510 uses the assigned source address for the source tile to fetch metadata included in an entry of routing tables 720 of router sub-system 700 to determine whether to stall the output of the packet to the destination port. The metadata, for example, can be in the format of example routing table entry format 610 shown in FIG. 6 and can include a 1-bit value to indicate stall or not stall, a 4-bit value to indicate a stall count and a 3-bit value to indicate which output or destination port of top channel 750A to route the packet received from the source tile.

In some examples, logic flow 1100 at block 1106 can stall the output of the packet for at least one unit of time based on the metadata indicating a stall. For these examples, a value of ‘1” in the 1-bit can indicate stall and the 4-bit value to indicate a stall count will indicate the at least one unit of time for the stall. The at least one unit of time can be a clock cycle and the stall count can indicate a number of clock cycles for which the stall is to last before the packet is released for output to the destination port.

According to some examples, logic flow 1100 at block 1108 can cause the packet to be outputted to the destination port. For example, the 3-bit value to indicate which output or destination port of top channel 750A to output the packet can include a direction encoding value (e.g., according to example direction encoding 620) to determine whether the packet is to be outputted to one of a west, east, north, south or local output or destination port to reach its destination. In some examples, the tile including the router circuitry 510 is also the destination tile. For these examples, the packet is routed towards a local output or destination port that sends the packet to compute elements 410-1 to 410-128.

The logic flow shown in FIG. 11 can be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a software or logic flow can be implemented by computer executable instructions stored on at least one non-transitory computer readable medium or machine readable medium, such as an optical, magnetic or semiconductor storage. The embodiments are not limited in this context.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

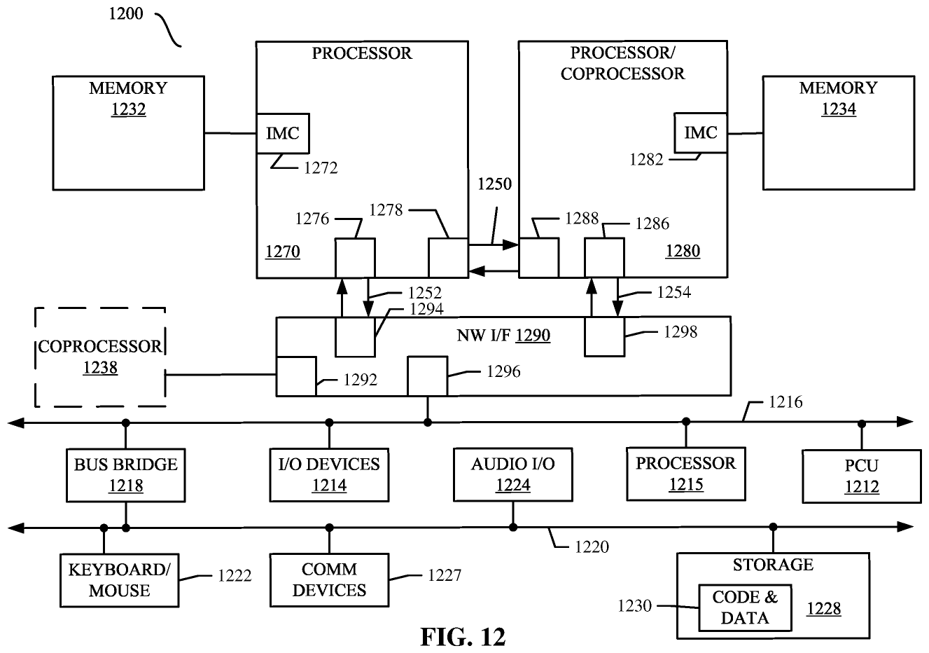

FIG. 12 illustrates an example computing system. Multiprocessor system 1200 is an interfaced system and includes a plurality of processors or cores including a first processor 1270 and a second processor 1280 coupled via an interface 1250 such as a point-to-point (P-P) interconnect, a fabric, and/or bus. In some examples, the first processor 1270 and the second processor 1280 are homogeneous. In some examples, first processor 1270 and the second processor 1280 are heterogenous. Though the example system 1200 is shown to have two processors, the system may have three or more processors, or may be a single processor system. In some examples, the computing system is a system on a chip (SoC).

Processors 1270 and 1280 are shown including integrated memory controller (IMC) circuitry 1272 and 1282, respectively. Processor 1270 also includes interface circuits 1276 and 1278; similarly, second processor 1280 includes interface circuits 1286 and 1288. Processors 1270, 1280 may exchange information via the interface 1250 using interface circuits 1278, 1288. IMCs 1272 and 1282 couple the processors 1270, 1280 to respective memories, namely a memory 1232 and a memory 1234, which may be portions of main memory locally attached to the respective processors.

Processors 1270, 1280 may each exchange information with a network interface (NW I/F) 1290 via individual interfaces 1252, 1254 using interface circuits 1276, 1294, 1286, 1298. The network interface 1290 (e.g., one or more of an interconnect, bus, and/or fabric, and in some examples is a chipset) may optionally exchange information with a co-processor 1238 via an interface circuit 1292. In some examples, the co-processor 1238 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1270, 1280 or outside of both processors, yet connected with the processors via an interface such as P-P interconnect, such that either or both processors' local cache information may be stored in the shared cache if a processor is placed into a low power mode.

Network interface 1290 may be coupled to a first interface 1216 via interface circuit 1296. In some examples, first interface 1216 may be an interface such as a Peripheral Component Interconnect (PCI) interconnect, a PCI Express interconnect or another I/O interconnect. In some examples, first interface 1216 is coupled to a power control unit (PCU) 1212, which may include circuitry, software, and/or firmware to perform power management operations with regard to the processors 1270, 1280 and/or co-processor 1238. PCU 1212 provides control information to a voltage regulator (not shown) to cause the voltage regulator to generate the appropriate regulated voltage. PCU 1212 also provides control information to control the operating voltage generated. In various examples, PCU 1212 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1212 is illustrated as being present as logic separate from the processor 1270 and/or processor 1280. In other cases, PCU 1212 may execute on a given one or more of cores (not shown) of processor 1270 or 1280. In some cases, PCU 1212 may be implemented as a microcontroller (dedicated or general-purpose) or other control logic configured to execute its own dedicated power management code, sometimes referred to as P-code. In yet other examples, power management operations to be performed by PCU 1212 may be implemented externally to a processor, such as by way of a separate power management integrated circuit (PMIC) or another component external to the processor. In yet other examples, power management operations to be performed by PCU 1212 may be implemented within BIOS or other system software.

Various I/O devices 1214 may be coupled to first interface 1216, along with a bus bridge 1218 which couples first interface 1216 to a second interface 1220. In some examples, one or more additional processor(s) 1215, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1216. In some examples, second interface 1220 may be a low pin count (LPC) interface. Various devices may be coupled to second interface 1220 including, for example, a keyboard and/or mouse 1222, communication devices 1227 and storage circuitry 1228. Storage circuitry 1228 may be one or more non-transitory machine-readable storage media as described below, such as a disk drive or other mass storage device which may include instructions/code and data 1230 and may implement the storage ‘ISAB03 in some examples. Further, an audio I/O 1224 may be coupled to second interface 1220. Note that other architectures than the point-to-point architecture described above are possible. For example, instead of the point-to-point architecture, a system such as multiprocessor system 1200 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

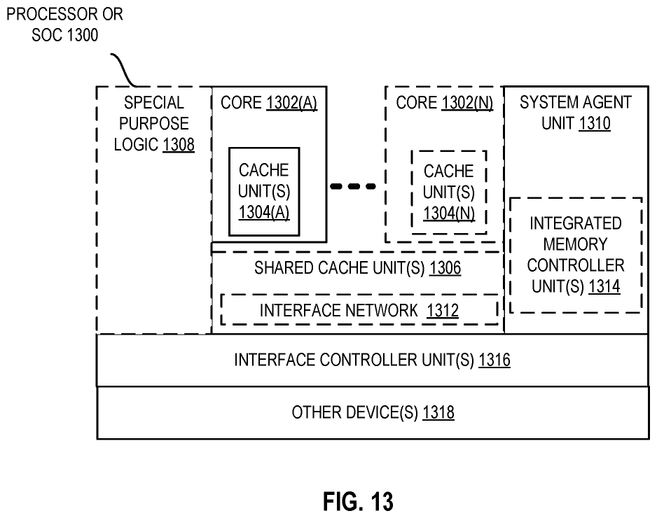

FIG. 13 illustrates a block diagram of an example processor and/or SoC 1300 that may have one or more cores and an integrated memory controller. The solid lined boxes illustrate a processor 1300 with a single core 1302(A), system agent unit circuitry 1310, and a set of one or more interface controller unit(s) circuitry 1316, while the optional addition of the dashed lined boxes illustrates an alternative processor 1300 with multiple cores 1302(A)-(N), a set of one or more integrated memory controller unit(s) circuitry 1314 in the system agent unit circuitry 1310, and special purpose logic 1308, as well as a set of one or more interface controller units circuitry 1316. Note that the processor 1300 may be one of the processors 1270 or 1280, or co-processor 1238 or 1215 of FIG. 12.

Thus, different implementations of the processor 1300 may include: 1) a CPU with the special purpose logic 1308 being integrated graphics and/or scientific (throughput) logic (which may include one or more cores, not shown), and the cores 1302(A)-(N) being one or more general purpose cores (e.g., general purpose in-order cores, general purpose out-of-order cores, or a combination of the two); 2) a coprocessor with the cores 1302(A)-(N) being a large number of special purpose cores intended primarily for graphics and/or scientific (throughput); and 3) a coprocessor with the cores 1302(A)-(N) being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1304(A)-(N) within the cores 1302(A)-(N), a set of one or more shared cache unit(s) circuitry 1306, and external memory (not shown) coupled to the set of integrated memory controller unit(s) circuitry 1314. The set of one or more shared cache unit(s) circuitry 1306 may include one or more mid-level caches, such as level 2 (L2), level 3 (L3), level 4 (L4), or other levels of cache, such as a last level cache (LLC), and/or combinations thereof. While in some examples interface network circuitry 1312 (e.g., a ring interconnect) interfaces the special purpose logic 1308 (e.g., integrated graphics logic), the set of shared cache unit(s) circuitry 1306, and the system agent unit circuitry 1310, alternative examples use any number of well-known techniques for interfacing such units. In some examples, coherency is maintained between one or more of the shared cache unit(s) circuitry 1306 and cores 1302(A)-(N). In some examples, interface controller units circuitry 1316 couple the cores 1302 to one or more other devices 1318 such as one or more I/O devices, storage, one or more communication devices (e.g., wireless networking, wired networking, etc.), etc.

In some examples, one or more of the cores 1302(A)-(N) are capable of multi-threading. The system agent unit circuitry 1310 includes those components coordinating and operating cores 1302(A)-(N). The system agent unit circuitry 1310 may include, for example, power control unit (PCU) circuitry and/or display unit circuitry (not shown). The PCU may be or may include logic and components needed for regulating the power state of the cores 1302(A)-(N) and/or the special purpose logic 1308 (e.g., integrated graphics logic). The display unit circuitry is for driving one or more externally connected displays.

The cores 1302(A)-(N) may be homogenous in terms of instruction set architecture (ISA). Alternatively, the cores 1302(A)-(N) may be heterogeneous in terms of ISA; that is, a subset of the cores 1302(A)-(N) may be capable of executing an ISA, while other cores may be capable of executing only a subset of that ISA or another ISA.

The following examples pertain to additional examples of technologies disclosed herein.

Example 1. An example apparatus can include at least one compute element arranged to execute NTT or iNTT computations, the at least one compute element maintained at a first tile of a plurality of tiles arranged in a 2D mesh interconnect-based architecture. The apparatus can also include router circuitry at the first tile. The router circuitry can receive a packet sent from a source tile from among the plurality of tiles. The source tile can include compute elements arranged to execute NTT or iNTT computations. The router circuitry can also, based on a source address for the source tile, fetch metadata included in an entry assigned to the source address. The entry can be maintained in a routing table. The metadata can indicate whether to stall an output of the packet to a destination port of the router circuitry and can indicate the destination port to route the packet. The router circuitry can also stall the output of the packet for at least one unit of time based on the metadata indicating a stall. The router circuitry can also cause the packet to be outputted to the destination port.

Example 2. The apparatus of example 1, the routing table can be capable of being reconfigured responsive to a change to the NTT or iNTT computations to be executed by compute elements at tiles included in the plurality of tiles in order to maintain contention-free routes through the plurality of tiles.

Example 3. The apparatus of example 1, the at least one compute element of the source tile can include butterfly circuits to generate 2 outputs based on 2 inputs to execute NTT or iNTT computations. For this example, the received packet can include data generated by butterfly circuits at the source tile that is from 1 of the 2 outputs.

Example 4. The apparatus of example 3, the router circuitry can also include a top channel router circuitry configured to route a first output from among the 2 outputs and can also include a bottom channel router circuitry configured to route a second output from among the 2 outputs.

Example 5. The apparatus of example 1, the NTT or iNTT computations can be associated with a 16,384 polynomial ring size to be used for execution of a fully homomorphic encryption workload, wherein the plurality of tiles includes 64 tiles, each tile including 128 compute elements.

Example 6. The apparatus of example 1, the first tile can also be a destination tile, and the destination port can route the packet to the at least one compute element of the first tile.

Example 7. The apparatus of example 1, the first tile is not a destination tile, and the destination port can route the packet towards the destination tile.

Example 8. The apparatus of example 1, wherein the router circuitry can include an east, a west, a north, a south or a local destination port. For this example, the metadata can include a direction encoding value to indicate which destination port to route the packet to cause the packet to be routed towards a destination tile.

Example 9. The apparatus of example 8, the router circuitry can be capable of concurrently routing separate packets via at least two of the east, the west, the north, the south or the local destination ports.

Example 10. The apparatus of example 1, the at least one unit of time can be at least one clock cycle.

Example 11. An example method can include receiving, at a first tile of a plurality of tiles arranged in a 2D mesh interconnect-based architecture, a packet sent from a source tile having compute elements arranged to execute NTT or iNTT computations. The method can also include fetching metadata included in an entry assigned to the source address based on a source address for the source tile. The entry can be maintained in a routing table. The metadata can indicate whether to stall an output of the packet to a destination port of router circuitry of the first tile and indicates the destination port to route the packet. The method can also include stalling the output of the packet for at least one unit of time based on the metadata indicating a stall. The method can also include causing the packet to be outputted to the destination port.

Example 12. The method of example 11, the routing table can be capable of being reconfigured responsive to a change to the NTT or iNTT computations to be executed by compute elements at tiles included in the plurality of tiles in order to maintain contention-free routes through the plurality of tiles.

Example 13. The method of example 11, the compute elements of the source tile can be butterfly circuits to generate 2 outputs based on 2 inputs to execute NTT or iNTT computations. For this example, the received packet can include data generated by butterfly circuits at the source tile that is from 1 of the 2 outputs.

Example 14. The method of example 13, the router circuitry of the first tile can include a top channel router circuitry configured to route a first output from among the 2 outputs and can also include a bottom channel router circuitry configured to route a second output from among the 2 outputs.

Example 15. The method of example 11, the NTT or iNTT computations can be associated with a 16,384 polynomial ring size to be used for execution of a fully homomorphic encryption workload, wherein the plurality of tiles includes 64 tiles, each tile including 128 compute elements.

Example 16. The method of example 11, the first tile can also be a destination tile, and the destination port is to route the packet to the compute elements of the first tile.

Example 17. The method of example 11, the first tile is not a destination tile, and the destination port can route the packet towards the destination tile.

Example 18. The method of example 11, the router circuitry of the first tile can include an east, a west, a north, a south or a local destination port. For this example, the metadata can include a direction encoding value to indicate which destination port to route the packet to cause the packet to be routed towards the destination tile.

Example 19. The method of example 18, the router circuitry of the first tile can be arranged to concurrently route separate packets via at least two of the east, the west, the north, the south or the local destination ports.

Example 20. The method of example 11, the at least one unit of time can be at least one clock cycle.

Example 21. An example at least one machine readable medium can include a plurality of instructions that in response to being executed by a system can cause the system to carry out a method according to any one of examples 11 to 20.

Example 22. An example apparatus can include means for performing the methods of any one of examples 11 to 20.

Example 23. An example system can include a source tile from among a plurality of tiles arranged in a 2D mesh interconnect-based architecture, the source tile can include compute elements arranged to execute NTT or iNTT computations. The system can also include a destination tile from among the plurality of tiles, the destination tile can also include compute elements arranged to execute NTT or iNTT computations. The system can also include an intermediate tile from among the plurality of tiles. The intermediate tile can include compute elements arranged to execute NTT or iNTT computations. The intermediate tile can also include router circuitry. The router circuitry can receive a packet sent from the source tile. The router circuitry can also, based on a source address for the source tile, fetch metadata included in an entry assigned to the source address. The entry can be maintained in a routing table. The metadata can indicate whether to stall an output of the packet to a destination port of the router circuitry and can indicate the destination port to route the packet to the destination tile. The router circuitry can also stall the output of the packet for at least one unit of time based on the metadata indicating a stall. The router circuitry can also cause the packet to be outputted to the destination port.

Example 24. The system of example 23, the routing table can be capable of being reconfigured responsive to a change to the NTT or iNTT computations to be executed by compute elements at tiles included in the plurality of tiles in order to maintain contention-free routes through the plurality of tiles.

Example 25. The system of example 23, the compute elements of the source tile comprise butterfly circuits can generate 2 outputs based on 2 inputs to execute NTT or iNTT computations. For this example, the received packet can include data generated by butterfly circuits at the source tile that is from 1 of the 2 outputs.

Example 26. The system of example 25, the router circuitry can include a top channel router circuitry configured to route a first output from among the 2 outputs and can also include a bottom channel router circuitry configured to route a second output from among the 2 outputs.

Example 27. The system of example 23, the NTT or iNTT computations can be associated with a 16,384 polynomial ring size to be used for execution of a fully homomorphic encryption workload, wherein the plurality of tiles include 64 tiles, each tile including 128 compute elements.

Example 28. The system of example 23, the router circuitry can include an east, a west, a north, a south or a local destination port. For this example, the metadata can include a direction encoding value to indicate which destination port to route the packet to cause the packet to be routed towards the destination tile.

Example 29. The system of example 23, the router circuitry can be capable of concurrently routing separate packets via at least two of an east, a west, a north, a south or a local destination ports.

Example 30. The system of example 23, the at least one unit of time can be at least one clock cycle.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

While various examples described herein could use the System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single integrated circuit (“IC”) die, or chip, the present disclosure is not limited in that respect. For example, in various examples of the present disclosure, a device or system could have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
at least one compute element arranged to execute number-theoretic-transform (NTT) or inverse-NTT (iNTT) computations, the at least one compute element at a first tile of a plurality of tiles arranged in a 2-dimensional mesh interconnect-based architecture; and
router circuitry at the first tile, the router circuitry to:
receive a packet sent from a source tile from among the plurality of tiles, wherein the source tile includes compute elements arranged to execute NTT or iNTT computations;
based on a source address for the source tile, fetch metadata included in an entry assigned to the source address, the entry to be maintained in a routing table, wherein the metadata indicates whether to stall an output of the packet to a destination port of the router circuitry and indicates the destination port to route the packet;
stall the output of the packet for at least one unit of time based on the metadata indicating a stall; and
cause the packet to be outputted to the destination port.

2. The apparatus of claim 1, wherein the routing table is capable of being reconfigured responsive to a change to the NTT or iNTT computations to be executed by compute elements at tiles included in the plurality of tiles in order to maintain contention-free routes through the plurality of tiles.

3. The apparatus of claim 1, wherein the at least one compute element of the source tile comprise butterfly circuits to generate 2 outputs based on 2 inputs to execute NTT or iNTT computations, wherein the received packet includes data generated by butterfly circuits at the source tile that is from 1 of the 2 outputs.

4. The apparatus of claim 3, wherein the router circuitry includes a top channel router circuitry configured to route a first output from among the 2 outputs and a bottom channel router circuitry configured to route a second output from among the 2 outputs.

5. The apparatus of claim 1, wherein the NTT or iNTT computations are associated with a 16,384 polynomial ring size to be used for execution of a fully homomorphic encryption workload, wherein the plurality of tiles includes 64 tiles, each tile including 128 compute elements.

6. The apparatus of claim 1, wherein the first tile is also a destination tile, and the destination port is to route the packet to the at least one compute element of the first tile.

7. The apparatus of claim 1, wherein the first tile is not a destination tile, and the destination port is to route the packet towards the destination tile.

8. The apparatus of claim 1, wherein the router circuitry includes an east, a west, a north, a south or a local destination port, wherein the metadata includes a direction encoding value to indicate which destination port to route the packet to cause the packet to be routed towards a destination tile.

9. The apparatus of claim 8, wherein the router circuitry is capable of concurrently routing separate packets via at least two of the east, the west, the north, the south or the local destination ports.

10. The apparatus of claim 1, wherein the at least one unit of time comprises at least one clock cycle.

11. A method comprising:
receiving, at a first tile of a plurality of tiles arranged in a 2-dimensional mesh interconnect-based architecture, a packet sent from a source tile having compute elements arranged to execute number-theoretic-transform (NTT) or inverse-NTT (iNTT) computations;
based on a source address for the source tile, fetching metadata included in an entry assigned to the source address, the entry to be maintained in a routing table, wherein the metadata indicates whether to stall an output of the packet to a destination port of router circuitry of the first tile and indicates the destination port to route the packet;
stalling the output of the packet for at least one unit of time based on the metadata indicating a stall; and
causing the packet to be outputted to the destination port.

12. The method of claim 11, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs, and wherein the router circuitry of the first tile includes a top channel router circuitry configured to route a first output from among the 2 outputs and a bottom channel router circuitry configured to route a second output from among the 2 outputs.

13. The method of claim 11, wherein the NTT or iNTT computations are associated with a 16,384 polynomial ring size to be used for execution of a fully homomorphic encryption workload, wherein the plurality of tiles includes 64 tiles, each tile including 128 compute elements.

14. The method of claim 11, wherein the router circuitry of the first tile includes an east, a west, a north, a south or a local destination port, wherein the metadata includes a direction encoding value to indicate which destination port to route the packet to cause the packet to be routed towards the destination tile.

15. A system comprising:
a source tile from among a plurality of tiles arranged in a 2-dimensional mesh interconnect-based architecture, the source tile includes compute elements arranged to execute number-theoretic-transform (NTT) or inverse-NTT (iNTT) computations;
a destination tile from among the plurality of tiles, the destination tile to also include compute elements arranged to execute NTT or iNTT computations; and
an intermediate tile from among the plurality of tiles, the intermediate tile to also include compute elements arranged to execute NTT or iNTT computations, wherein the intermediate tile includes router circuitry to:
receive a packet sent from the source tile;
based on a source address for the source tile, fetch metadata included in an entry assigned to the source address, the entry to be maintained in a routing table, wherein the metadata indicates whether to stall an output of the packet to a destination port of the router circuitry and indicates the destination port to route the packet to the destination tile;
stall the output of the packet for at least one unit of time based on the metadata indicating a stall; and
cause the packet to be outputted to the destination port.

16. The system of claim 15, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

17. The system of claim 16, wherein the router circuitry includes a top channel router circuitry configured to route a first output from among the 2 outputs and a bottom channel router circuitry configured to route a second output from among the 2 outputs.

18. The system of claim 15, wherein the NTT or iNTT computations are associated with a 16,384 polynomial ring size to be used for execution of a fully homomorphic encryption workload, wherein the plurality of tiles include 64 tiles, each tile including 128 compute elements.

19. The system of claim 15, wherein the router circuitry includes an east, a west, a north, a south or a local destination port, wherein the metadata includes a direction encoding value to indicate which destination port to route the packet to cause the packet to be routed towards the destination tile.

20. The system of claim 15, wherein the at least one unit of time comprises at least one clock cycle.
